(19) United States
(12) Patent Application Publication
(10) Pub. No.: US 2017/0090820 A1
(43) Pub. Date: Mar. 30, 2017

(54) METHOD AND DEVICE FOR OPERATING A MANY-CORE SYSTEM

(71) Applicant: Robert Bosch GmbH, Stuttgart (DE)

(72) Inventors: Matias Maspoli, Stuttgart (DE); Matthias Knauss, Schorndorf (DE); Marcin Hubert Nowacki, Weil Der Stadt (DE)

(21) Appl. No.: 15/267,855

(22) Filed: Sep. 16, 2016

(30) Foreign Application Priority Data
Sep. 28, 2015 (DE) 102015218589.3

(51) Int. Cl. G06F 3/06

(52) U.S. Cl. CPC G06F 3/0653; G06F 3/0611; G06F 3/0683

(57) ABSTRACT

A device for operation of a system having a plurality of storage modules and one or a plurality of computing units. The device ascertains, for a first storage module of the plurality of storage modules, an overall access time of a computing unit of the computing unit(s) to this one data element in this first storage module, as a function of a read access frequency, and ascertains the overall access time, also as a function of the duration of a read access of this computing unit to this first storage module. The device decides, as a function of this ascertained overall access time of this computing unit to this data element in this first storage module, whether the data element is stored in this first storage module or in another of the storage module(s).

### CROSS REFERENCE

The present application claims the benefit under 35 U.S.C. §119 of German Patent Application No. DE 102015218589.3 filed on Sep. 28, 2015, which is expressly incorporated herein by reference in its entirety.

### FIELD

The present invention relates to a device and to a method for operating a system having a plurality of storage modules and a plurality of computing units, and to a device and a method for generating program code for such a system.

### BACKGROUND INFORMATION

German Patent Application No. DE 10 2013 224 702 A1 describes a control device for a motor vehicle, the control device including at least two processor cores and a global memory, each processor core including a respective local memory, and each processor core being set up to access only its own local memory and being set up to access neither the local memories of the other processor cores nor the global memory, a coordination unit being set up to read in data from the global memory of the control device and to write this data to the local memories of the individual processor cores, and to read in data from the local memories of the individual processor cores and to write this data to the global memory and/or to the local memory of the other processor cores.

### SUMMARY

If it is desired to optimize a system having one or a plurality of computing units and a plurality of storage modules, an important step is to store data elements used by one or more of the computing units in an optimally selected storage module.

In embedded systems, in particular in control devices in motor vehicles, already upon the generation of program code for each data element it is determined in which storage module the data element is stored.

An example embodiment in accordance with the present invention may have the advantage that it can be efficiently decided, in an automated fashion, in which of the storage modules the data element is stored. Advantageous developments are described herein.

In a first aspect, the present invention relates to a method for operating a system having a plurality of storage modules and having one or a plurality of computing units, it being decided whether a data element, in particular a variable, is stored in a first storage module of a plurality of storage modules of the system, an overall access time of a computing unit of one or a plurality of computing units to this one data element in this first storage module being ascertained for the first storage module as a function of a read access frequency, the read access frequency indicating how often this computing unit of the system carries out read accesses to this data element, in particular via a communication connection, and the overall access time also being ascertained as a function of an average duration of a read access of this computing unit to this first storage module, this average duration indicating the duration of such a read access when the data element is stored in this computing unit, it being decided, as a function of this ascertained overall access time of this computing unit to this data element in this first storage module, whether the data element is stored in this first storage module or in another storage module of the plurality of storage modules.

The frequency of the read accesses of this computing unit to this data element can here be a relative frequency. The data elements can in particular be variables, but can also be larger data blocks.

The frequency of the read accesses and/or the average duration, i.e., the duration that is to be expected, of the read access can be stored for example in a table.

In a development of this aspect, the overall access time of this computing unit to this data element in this first storage module also being ascertained as a function of a write access frequency, the write access frequency indicating how often the computing unit of the one or plurality of computing units of the system carries out write accesses to this data element, in particular via a communication connection, and the overall access time also being ascertained as a function of an average duration of a write access of this computing unit to this first storage module. The precision of this method is increased by the taking into account of write accesses.

In a further aspect, it can be provided that an overall access time of all computing units to this data element in this first storage module is ascertained as the sum of the overall access times of each of the computing units to this data element in this first storage module, it being decided, as a function of this overall access time of all computing units to this data element in this first storage module, whether the data element is stored in this first storage module or in another storage module of the plurality of storage modules. In particular, it can be provided that the data element is stored in this first storage module when the overall access time of all computing units to this data element in this first storage module is smaller than an overall access time of all computing units to this data element in every other of the plurality of storage modules. This is a particularly simple optimal method for determining the optimal storage location of the data element.

In a further aspect, it can be provided that when it is decided that this data element is stored in this first storage module, this data element is added to a list of data elements provided for storage in this first storage module, it being ascertained, if a storage capacity of this first storage module is not adequate to simultaneously store all these data elements of this list, which of these data elements are provided for storage in another of the multiplicity of storage modules. Through this retroactive reallocation of data elements to storage locations, it is possible in a particularly simple manner, under the boundary condition of limited storage capacity in the storage modules, to arrive at an assignment of data elements to storage modules that is as good as possible.

A particularly simple method for obtaining this assignment can be that for every other of the plurality of storage modules it is provided that a list is created with all data elements provided for storage in the first storage module, a transfer cost quantity being associated with each of these data elements, it being decided, for the data elements with which the lowest transfer cost quantity is associated, that these elements are stored not in the first storage module, but rather in another of the plurality of storage modules.

In a further simple development, here it can be provided that the transfer cost quantity in the list for a second storage module is ascertained as the difference between the overall access time of all computing units to this data element in this second storage module and the overall access time of all computing units to this data element in the first storage module.

Here it can be provided in particular that, in the ascertaining of the transfer cost quantity, this difference is divided by a size of the data element (for example in bytes). In this way, the method can easily also be applied to data elements having different sizes.

In a development, it can be provided that the described method is applied recursively. In particular, it can be provided that for each of the data elements for which it has been decided that it is to be stored not in the first storage module but rather in another of the multiplicity of storage modules, the described method can be applied as required in order to ascertain a further storage module from a reduced plurality of storage modules in which this data element is stored, the reduced plurality of storage modules being equal to the plurality of storage modules without the first storage module. In this way, a complete assignment of the data elements to the storage modules can be obtained in a particularly simple and efficient manner.

If v designates the number of data elements and m designates the number of storage modules, the problem of the assignment of the data elements to storage modules is of complexity O(vm^{v}). In contrast, the complexity of the proposed algorithm is O(v+f^{a}), where f designates the number of storage modules whose storage capacity would be exceeded on the basis of the assignment of the data elements to this storage element, and a designates the number of data elements that would have to be assigned to a different storage module.

In another aspect, the present invention relates to a method for the automatic generation of program code for a system having a plurality of computing modules and a plurality of storage modules, it being decided, using one of the methods according to the present invention, for a data element in which of the storage modules this data element is stored, and the program code being correspondingly generated.

In further aspects, the present invention relates to a computer program for carrying out the method and to a machine-readable storage medium on which the computer program is stored. The method can be used for example in a motor vehicle.

The Figures show, as examples, particularly advantageous specific embodiments of the present invention.

### BRIEF DESCRIPTION OF THE DRAWINGS

FIG. 1 shows the design of a system having a plurality of computing units and a plurality of storage modules.

FIG. 2 shows various specific embodiments of a data stream.

FIG. 3 shows the design of a system according to the present invention, according to a specific embodiment.

FIG. 4 shows the sequence of a method according to a specific embodiment of the present invention.

FIG. 5 shows the sequence of a method according to a further specific embodiment of the present invention.

FIG. 6 shows the sequence of a method according to a further specific embodiment of the present invention.

### DETAILED DESCRIPTION OF EXAMPLE EMBODIMENTS

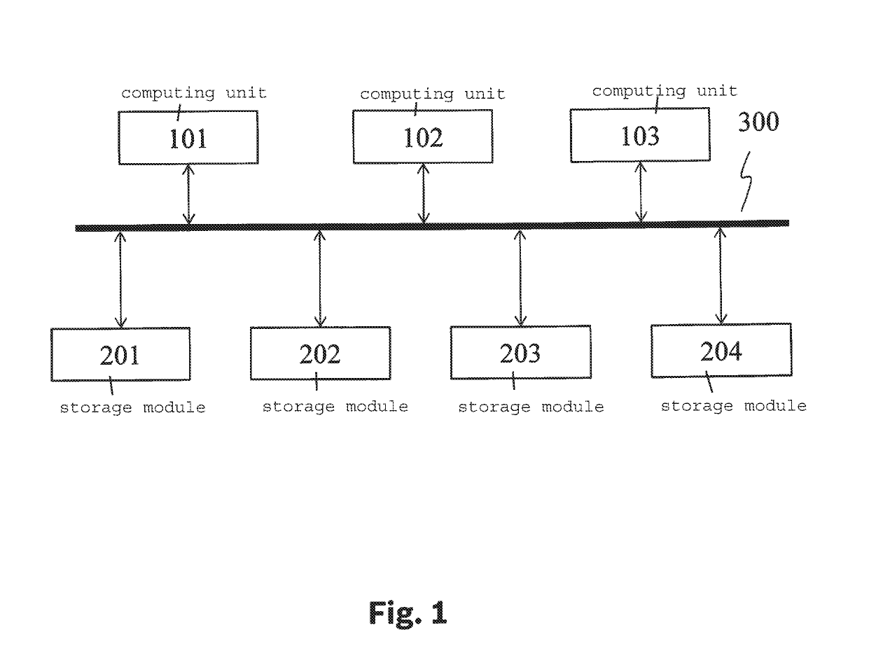

FIG. 1 shows the advantage of a system, in particular of a control device, that can for example be used in a motor vehicle. Provided is a plurality of computing units 101, 102, 103, that communicate with a plurality of storage modules 201, 202, 203, 204 via a data bus 300. Data elements, in particular variables, that are accessed by computing units 101, 102, 103 are respectively stored on one of the storage modules 201, 202, 203, 204. The present invention can be generally used on any system having at least one computing unit and at least two storage modules.

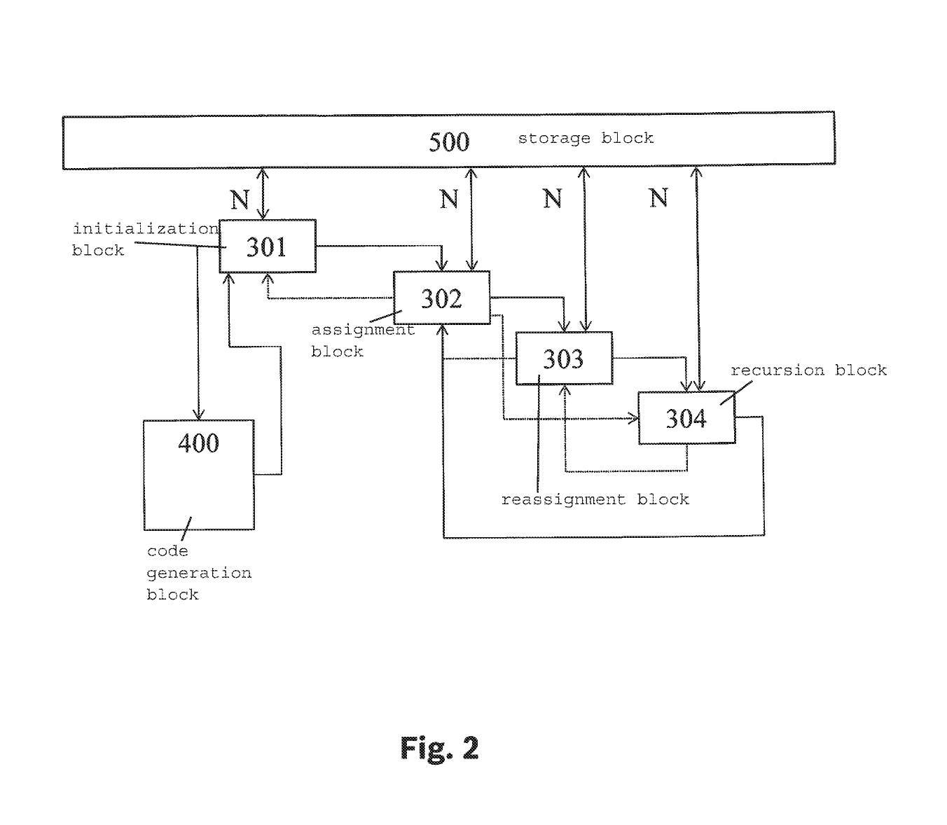

FIG. 2 shows a preferred system for generating program code for running on the system according to FIG. 1. Shown is an initialization block 301, an assignment block 302, a reassignment block 303, and a recursion block 304. These 4 blocks communicate with a storage block 500 via a network N.

The arrows illustrate the information flows in this system. A code generation block 400 holds the information for generating program code that is intended to run on the system shown in FIG. 1. In the code generation block there is a list of data elements that the program code is to store in storage modules 201, 202, 203, 204 when running on the system shown in FIG. 1.

Initialization block 301 calls assignment block 302, assignment block 302 calls reassignment block 303, reassignment block 303 calls recursion block 304, and recursion block 304 again calls assignment block 302. The returns of the blocks are shown in broken lines. From recursion block 304, branching takes place back to reassignment block 303, and from reassignment block 303 branching takes place back to assignment block 302. From assignment block 302, branching back takes place as a function of the calling block: if assignment block 302 was called by initialization block 301, branching takes place back to initialization block 301. If assignment block 302 was called by assignment block 302, branching takes place back to assignment block 302. The algorithm for the assignment of data elements to storage modules 201, 202, 203, 204 ends in initialization block 301. Subsequently, branching can take place to code generation block 400, in which program code for the system shown in FIG. 1 is generated in such a way that the data elements are stored in storage modules 201, 202, 203, 204, selected according to the described algorithm.

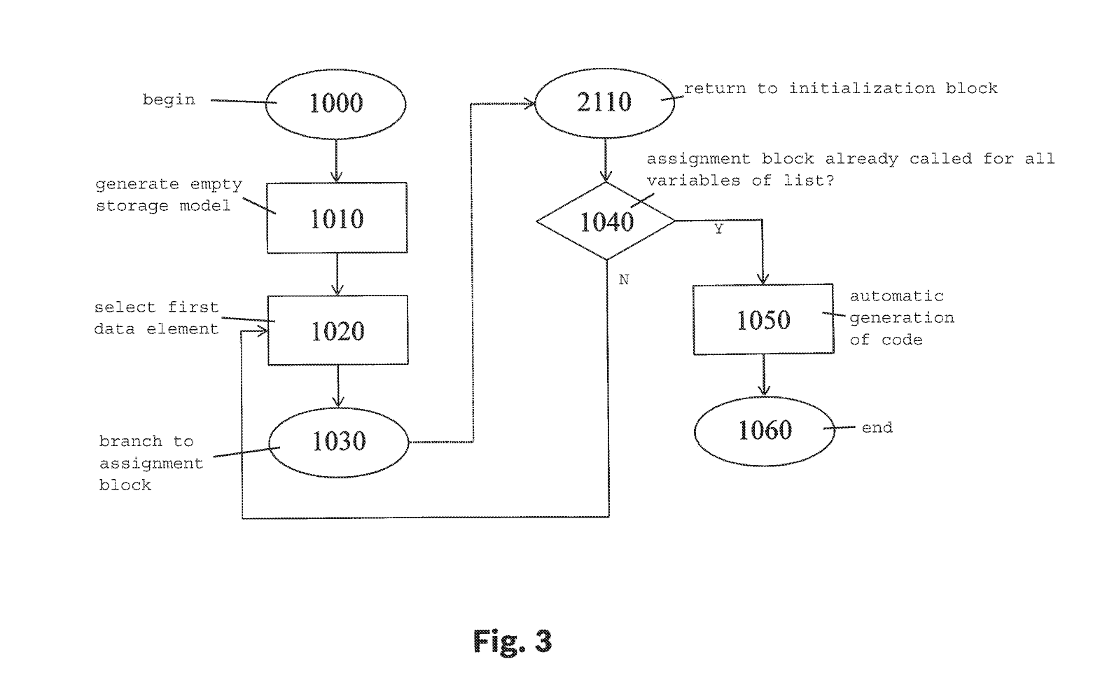

FIG. 3 shows the sequence of the method that can run in initialization block 301. The method begins at step 1000. In the following step 1010, an empty storage model is generated in which the assignments of the data elements to the storage modules 201, 202, 203, 204 are to be stored. A variable that indicates the summed overall costs of the storage assignments in this storage model is initialized to the value 0.

In the following step 1020, a first data element is selected from the list of data elements. This data element is designated “current data element.” The method can also be realized as a loop over all data elements of the list.

In the following step 1030, branching takes place to assignment block 302. The storage model and the current data element are delivered to the assignment block.

In step 2110, after assignment block 302 has finished the method returns to initialization block 301. Initialization block 301 receives the updated storage model from the assignment block. In the following step 1040, it is checked whether assignment block 302 has already been called for all variables of the list of data elements. If this is the case, then optionally in step 1050 the automatic generation of program code is called by code generation block 400. The method ends in the following step 1060.

If first assignment block 302 has not yet been called for all variables of the list, branching takes place back to step 1020.

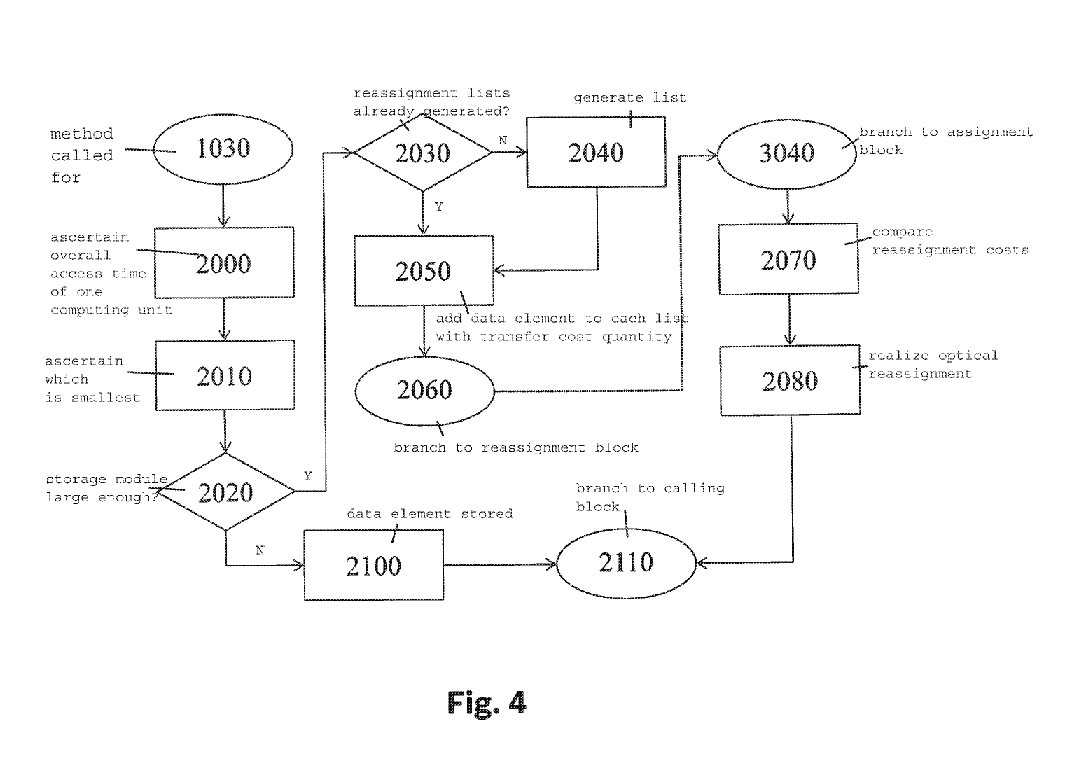

FIG. 4 shows the sequence of the method running in assignment block 302. In step 1030, the method is called.

There follows step 2000, in which for each of the storage modules 201, 202, 203, 204, an overall access time T_CVR of one of the computing units 101, 102, 103 to the data element selected in step 1020 is ascertained if the variable is stored on one of the storage modules 201, 202, 203, 204.

The letter C designates a concrete computing unit, and the letter R designates a concrete storage module. The overall access time T_CVR then designates the access duration of computing unit C if the data element is stored on storage module R. For example, it can be ascertained from a table how often computing unit C makes a read access to data element V. This number, which can also be normed as a relative frequency relative to the totality of all read accesses of one of the computing units 101, 102, 103 to some one of the data elements, is designated LACC_CV. An average access duration that computing unit C requires to storage module R is for example also stored in a table, and is designated LTicks_CR.

The overall access time T_CVR is then calculated as

T_CVR=LACC_CV*LTicks_CR/fC

where fC designates a frequency of computing unit C.

Optionally, for the calculation of overall access time T_CVR, the write accesses of computing unit C to data element V can also be taken into account. If SACC_CV analogously designates the frequency of write accesses of computing unit C to data element V, and STicks_CR analogously designates the average access duration, then the overall access time T_CVR can be calculated as

T_CVR=LACC_CV*LTicks_CR/fC+SACC_CV*Sticks_CR/fC.

In the norming of the frequencies LACC_CV and SACC_CV, it is then advantageous if they relate to the same basic totality, i.e., the totality of all read or write accesses of one of the computing units 101, 102, 103 to some one of the data elements.

Subsequently, an overall access time of all computing units to data element V in storage module R can be ascertained as

T_VR=Σ_{C}T_CVR

where, in the sum, the running variable C runs over all computing units 101, 102, 103 of the system. This overall access time is ascertained for each of the storage modules 201, 202, 203, 204; i.e., the overall access time T_VR is ascertained for each storage module R.

In the following step 2010 it is ascertained for which of the storage modules R the ascertained overall access time T_VR is smallest. Data element V is assigned to this storage module R. In the following, storage module R is also designated “current storage module” R.

In step 2020, it is checked whether storage module R, to which data element V was assigned, is large enough to simultaneously hold all the data elements assigned thereto. For example, it can be checked whether the sum of the storage requirements of each of the data elements assigned to storage module R is smaller than an available overall storage space of storage module R. If this is the case, step 2100 follows; otherwise step 2030 follows.

If it can be guaranteed that storage module R is large enough in every case, then step 2020 can be omitted, and branching can take place from step 2010 immediately to step 2100.

In step 2030 it is checked whether reassignment lists have already been generated. If no reassignment lists have yet been produced, there follows step 2040, in which for every other of the storage modules 201, 202, 203, 204, i.e. for each of the storage modules 201, 202, 203, 204 apart from storage module R, a list is generated with all the data elements that are provided for storage in storage module R. Let this other storage module be designated R2. Data element V has not yet been added to the reassignment lists. Each data element V′ of the list is assigned the transfer cost quantity ΔTV′, which designates the growth in overall access time if the data element is not stored in storage module R, but rather is instead stored in storage module R′. The reassignment lists are added to the storage model.

Analogous to the ascertaining described above of the quantity T_VR, quantity T_V′R′ can be ascertained in that the steps described in step 2000 are carried out not for storage module R, but rather for storage module R′, and are carried out not for data element V, but rather for data element V′. Likewise, the quantity T_V′R can be ascertained in that the steps described in step 2000 are carried out not for data element V, but rather for data element V′. The transfer cost quantity can then be ascertained as

ΔTV′=(T_V′R′−T_V′R)/nV′

where nV′ designates the size, i.e. the storage requirement, of data element V′ (e.g. in a number of bytes).

Step 2050 follows. If in step 2030 it was determined that reassignment lists are already present, step 2050 likewise follows. In step 2050, data element V is added to each of the reassignment lists and with it the transfer cost quantity

ΔTV=(T_VR′−T_VR)/nV.

There follows step 2060, in which branching takes place to reassignment block 303.

In step 3040, from reassignment block 303 branching takes place back to assignment block 302. The following steps 2070 to 2090 are described in more detail below.

In step 2100, to the storage module generated in step 1010 the assignment is added that data element C is stored in storage module R. In addition, to the summed overall costs are added the overall costs of the assignment of data element V to storage module R, i.e., T_VR.

There follows step 2110, in which branching takes place back to the calling block, for example initialization block 301. Here, the costs arising through the assignment of data element V to storage module R, i.e., T_VR, and the data model are delivered to the calling block.

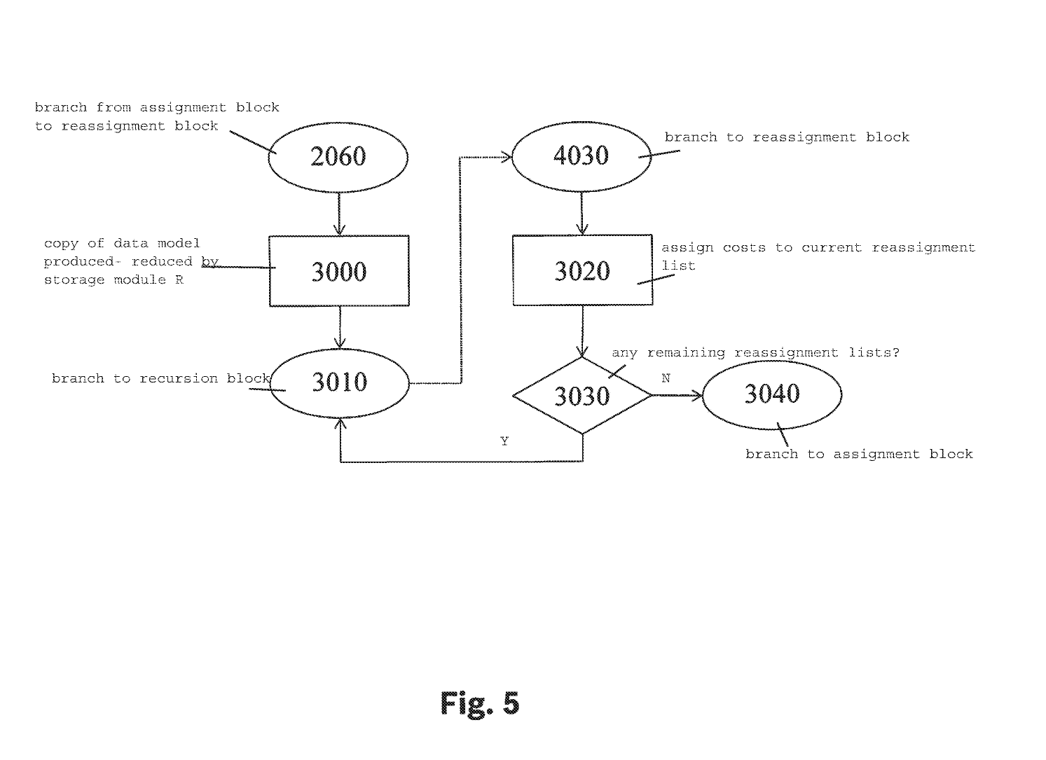

FIG. 5 illustrates the method in reassignment block 303. In step 2060, branching takes place from assignment block 302 to reassignment block 303. In the following step 3000, a first of the reassignment lists assigned to current storage module R, i.e. that describe a possible reassignment of a data element from storage module R to another storage module R′, is selected. This reassignment list is designated in the following as “current reassignment list.”

In step 3000, in addition a copy of the data model, reduced by storage module R, is produced. That is, a copy of the data model is produced but all assignments of data elements to storage module R are not copied. Reassignment lists from storage module R to another storage module R′, or from another storage module R′ to storage module R, are also not copied.

There follows step 3010, in which branching takes place to recursion block 304. In step 4030, branching takes place from recursion block 304 back to reassignment block 303.

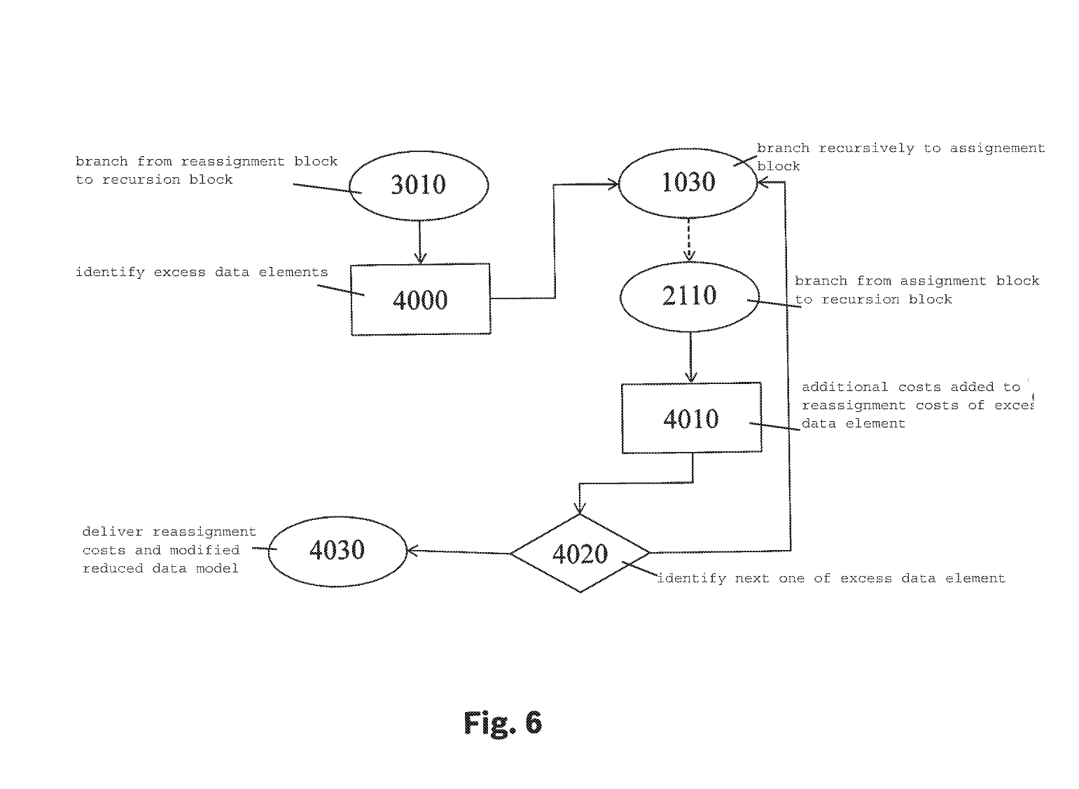

FIG. 6 illustrates the method in recursion block 304. In step 3010, branching takes place from reassignment block 303 to recursion block 303. In the following step 4000, excess data elements of the current reassignment list are identified. These are the data elements of the current reassignment list with which the lowest transfer costs are associated. These can for example be identified in such a way that the data elements of the current reassignment list are arranged in order according to the associated transfer costs, and that then, beginning with the lowest associated transfer costs, successive data elements are removed from the current transfer list until the storage requirement of the data elements remaining in the current transfer list is smaller than the available overall storage space in current storage module R. The data elements removed in this way form the excess data elements. A variable that indicates the reassignment costs of the excess data elements is initialized to the value 0.

In step 4000, a first of these excess data elements is now selected. Let this be designated the current excess data element. Subsequently, step 1030 branches recursively to assignment block 302. Differing from the case of calling from initialization block 301, this call takes place, not with the current data element and storage model, but rather with the current excess data element and the reduced storage model.

In step 2110, branching takes place from assignment block 302 back to recursion block 304. Recursion block 302 supplies to recursion block 304 the additional costs for the addition of the current excess data element and the reduced data model modified by it.

In the following step 4010, these additional costs are added to the reassignment costs of the excess data elements. There follows step 4020, in which a next one of the excess data elements is identified as the current excess data element, and branching takes place to step 1030, where a new recursive branching to assignment block 302 takes place.

If step 1030 has been called for each of the excess data elements, there follows step 4030, in which the reassignment costs and the modified reduced data model are delivered back to reassignment block 303.

In the following step 3020 (FIG. 5), these additional costs are assigned to the current reassignment list. There follows step 3030, in which it is checked whether there remain any reassignment lists. If this is the case, a next reassignment list is selected as the current reassignment list. There follows step 3010, in which a new branching to recursion block 304 takes place.

Otherwise there follows step 3040, in which branching takes place back to assignment block 302. Assignment block 302 receives the modified reduced data model and the reassignment costs. In assignment block 302, there follows step 2070, in which the reassignment costs of the reassignment lists are compared to one another, and of the reassignment lists the one whose reassignment costs are the lowest is selected. This reassignment list is designated “optimal reassignment.”

There follows step 2080 in which the optimal reassignment is realized, i.e., in the storage model the assignment of the excess data elements to the current data storage R is deleted, and instead is assigned to the other data storage R′ with which this optimal reassignment is associated.

There follows step 2110, in which branching takes place back to the calling block, for example initialization block 301. Here, the costs arising through the assignment of data element V to storage module R, i.e., the reassignment costs, and the data model are delivered to the calling block.

Those skilled in the art will understand that this message can be implemented both in hardware and in software. Furthermore, it is standard knowledge for those skilled in the art that the described recursive algorithm, like any recursive algorithm, can also be implemented sequentially.

What is claimed is:

1. A method for operating a system having a plurality of storage modules and one or a plurality of computing units, the method comprising:
deciding whether a data element is stored in a first storage module of a plurality of storage modules of the system;
ascertaining for the first storage module of the plurality of storage modules, an overall access time of a computing unit of the one or plurality of computing units to the data element in the first storage module as a function of a read access frequency, the read access frequency indicating how often the computing unit of the system carries out read accesses to the data element;
ascertaining an overall access time as a function of a duration of a read access of the computing unit to the first storage module; and
determining, as a function of the ascertained overall access time of the computing unit to the data element in the first storage module, whether the data element is stored in the first storage module or in another storage module of the plurality of storage modules.

2. The method as recited in claim 1, wherein the data element is a variable.

3. The method as recited in claim 1, wherein the overall access time of the computing unit to the data element in the first storage module also being ascertained as a function of a write access frequency, the write access frequency indicating how often the computing unit of the one or plurality of computing units of the system carries out write accesses to the data element, and the overall access time also being ascertained as a function of a duration of a write access of the computing unit to the first storage module.

4. The method as recited in claim 1, wherein the overall access time of the computing unit to the data element in the first storage module being ascertained as a function of the equation T_CV=LACC_CV*LTicks_CR+SACC_CV*STicks_CR, in which T_CV is the overall access time of the computing unit to the data element, LACC_CV is the read access frequency, LTicks_CR is the duration of the read access, SACC_CV is write access frequency and STicks_CR is duration of the write access.

5. The method as recited in claim 1, wherein an overall access time of all computing units to the data element in the first storage module being ascertained as a sum of overall access times of each of the computing units to the data element in the first storage module, and it being decided, as a function of the overall access time of all computing units to the data element in the first storage module, whether the data element is stored in the first storage module or in another storage module of the plurality of storage modules.

6. The method as recited in claim 1, further comprising:
adding the data element, when it is decided that the data element is stored in the first storage module, to a list of data elements provided for storage in the first storage module; and
if a storage capacity of the first storage module is not sufficient to simultaneously store all these data elements of the list, ascertaining which of the data elements are provided for storage in others of the multiplicity of storage modules.

7. The method as recited in claim 6, further comprising:
for every other of the multiplicity of storage modules, creating a list with all data elements provided for storage in the first storage module, a transfer cost quantity being associated with each of the data elements; and
for the data elements with which a lowest transfer cost quantity is associated, deciding that the data elements are stored not in the first storage module but rather in another of the multiplicity of storage modules.

8. The method as recited in claim 7, wherein the transfer cost quantity in the list for a second storage module is ascertained as a quotient between a difference between an overall access time of all computing units to the data element in the second storage module and an overall access time of all computing units to the data element in the first storage module divided by a size of the data element.

9. The method as recited in claim 8, wherein the method as recited in claim 8 is used for each of the data elements for which it has been decided that it is stored not in the first storage module but rather in another of the multiplicity of storage modules, to ascertain a further storage module from a reduced plurality of storage modules in which this data element is stored, the reduced plurality of storage modules being equal to the plurality of storage modules without the first storage module.

10. A method for the automatic generation of program code for a system having one or a plurality of computing modules and a plurality of storage modules, the method comprising:
deciding whether a data element is stored in a first storage module of a plurality of storage modules of the system;
ascertaining for the first storage module of the plurality of storage modules, an overall access time of a computing unit of the one or plurality of computing units to the data element in the first storage module as a function of a read access frequency, the read access frequency indicating how often the computing unit of the system carries out read accesses to the data element;
ascertaining an overall access time as a function of a duration of a read access of the computing unit to the first storage module;
determining, as a function of the ascertained overall access time of the computing unit to the data element in the first storage module, whether the data element is stored in the first storage module or in another storage module of the plurality of storage modules; and
generating corresponding program code based on the determining.

11. A device set up for the operation of a system having a plurality of storage modules and one or a plurality of computing units, the device set up to:
ascertain, for a first storage module of the plurality of storage modules, an overall access time of a computing unit of the one or plurality of computing units to the data element in the first storage module, as a function of a read access frequency, the read access frequency indicating how often the computing unit of the system carries out read accesses to this data element;
ascertain an overall access time also as a function of the duration of a read access of the computing unit to the first storage module; and
determine, as a function of the ascertained overall access time of the computing unit to the data element in the first storage module, whether the data element is stored in the first storage module or in another storage module of the plurality of storage modules.

12. The device as recited in claim 11, wherein the device is further set up to:
ascertain the overall access time of the computing unit to the data element in the first storage module also as a function of a write access frequency, the write access frequency indicating how often the computing unit of the one or plurality of computing units of the system carries out write accesses to the data element; and
ascertain the overall access time also as a function of a duration of a write access of the computing unit to the first storage module.

13. The device as recited in claim 11, wherein the device is set up to ascertain the overall access time of the computing unit to the data element in the first storage module as a function of the equation T_CV=LACC_CV*LTicks_CR+SACC_CV*STicks_CR, in which T_CV is T_CV is the overall access time of the computing unit to the data element, LACC_CV is the read access frequency, LTicks_CR is the duration of the read access, SACC_CV is write access frequency and STicks_CR is duration of the write access.

14. The device as recited in claim 11, wherein the device is further set up to:
ascertain an overall access time of all computing units to the data element in the first storage module as a sum of the overall access times of each of the computing units to the data element in the first storage module;
decide, as a function of this overall access time of all computing units to the data element in this first storage module, whether the data element is stored in the first storage module or in another storage module of the one or plurality of storage modules.

15. The device as recited in claim 11, wherein the device is further set up to:
add, when it has decided that the data element is stored in the first storage module, the data element to a list of data elements provided in the first storage module for storage; and
ascertain, if a storage capacity of this first storage module is not sufficient to simultaneously store all data elements of the list, which of the data elements are provided for storage in others of the plurality of storage modules.

16. The device as recited in claim 15, wherein the device is further set up to:
provide, for each other of the plurality of storage modules, for creation of a list having all data elements provided for storage in the first storage module;
associate a transfer cost quantity with each of the data elements; and
decide, for the data elements with which a lowest transfer cost quantity is associated, that those data elements are stored not in the first storage module, but rather in another of the plurality of storage modules.

17. The device as recited in claim 16, wherein the device is further set up to:
ascertain a transfer cost quantity in a list for a second storage module as a difference between the overall access time of all computing units to the data element in the second storage module and the overall access time of all computing units to the data element in the first storage module.

18. The device as recited in claim 17, wherein the device is set up to use, for each of the data elements for which it was decided that it is stored not in the first storage module but rather in another of the multiplicity of storage modules, a method to ascertain a further storage module from a reduced plurality of storage modules in which this data element is stored, the reduced plurality of storage modules being equal to the multiplicity of storage modules without the first storage module.

19. A device for automatic generation of program code for a system having one or a plurality of computing modules and a plurality of storage modules, the device being set up to:
decide whether a data element is stored in a first storage module of a plurality of storage modules of the system;
ascertain for the first storage module of the plurality of storage modules, an overall access time of a computing unit of the one or plurality of computing units to the data element in the first storage module as a function of a read access frequency, the read access frequency indicating how often the computing unit of the system carries out read accesses to the data element;
ascertain an overall access time as a function of a duration of a read access of the computing unit to the first storage module;
determine, as a function of the ascertained overall access time of the computing unit to the data element in the first storage module, whether the data element is stored in the first storage module or in another storage module of the plurality of storage modules; and
generate corresponding program code as a function of the determining.

20. A non-transitory machine-readable storage medium on which is stored a computer program for operating a system having a plurality of storage modules and one or a plurality of computing units, the computer program, when executed by a computer, causing the computer to perform:
deciding whether a data element is stored in a first storage module of a plurality of storage modules of the system;
ascertaining for the first storage module of the plurality of storage modules, an overall access time of a computing unit of the one or plurality of computing units to the data element in the first storage module as a function of a read access frequency, the read access frequency indicating how often the computing unit of the system carries out read accesses to the data element;
ascertaining an overall access time as a function of a duration of a read access of the computing unit to the first storage module; and
determining, as a function of the ascertained overall access time of the computing unit to the data element in the first storage module, whether the data element is stored in the first storage module or in another storage module of the plurality of storage modules.

21. A computer for operating a system having a plurality of storage modules and one or a plurality of computing units, the computer designed to:
decide whether a data element is stored in a first storage module of a plurality of storage modules of the system;
ascertain for the first storage module of the plurality of storage modules, an overall access time of a computing unit of the one or plurality of computing units to the data element in the first storage module as a function of a read access frequency, the read access frequency indicating how often the computing unit of the system carries out read accesses to the data element;
ascertain an overall access time as a function of a duration of a read access of the computing unit to the first storage module; and
determine, as a function of the ascertained overall access time of the computing unit to the data element in the first storage module, whether the data element is stored in the first storage module or in another storage module of the plurality of storage modules.
